(19) United States
(12) Patent Application Publication
(10) Pub. No.: US 2024/0035668 A1
(43) Pub. Date: Feb. 1, 2024

(54) Solenoid Actuated Redundant Shutoff Safety Valve for Gas Appliances

(71) Applicant: Morgan Reynolds, Itasca, IL (US)

(72) Inventor: Morgan Reynolds, Itasca, IL (US)

(21) Appl. No.: 18/215,931

(22) Filed: Jun. 29, 2023

Related U.S. Application Data
(60) Provisional application No. 63/392,198, filed on Jul. 26, 2022.

(51) Int. Cl. F24C 3/12; F16K 31/06; F23N 1/00

(52) U.S. Cl. CPC F24C 3/126; F16K 31/06; F23N 1/007

(57) ABSTRACT

A gas appliance, such as a gas range, is provided with a master shutoff valve, preferably as an electronic solenoid valve so that when in the “off” position, the leak rate may be cut up to 90% and to provide redundancy as it relates to ensuring the appliance is “off” when desired to be in an off configuration. The master shutoff valve may be controlled with an electronics module which assists in providing signals to position other valves and/or control or monitor ignition within the appliance.

### CLAIM OF PRIORITY

This application claims the benefit of U.S. Provisional Application No. 63/392,198 filed Jul. 26, 2022, which is incorporated herein by reference in its entirety.

### FIELD OF INVENTION

The present invention relates to providing a redundant safety shutoff valve for gas appliances that has a leak rate of no greater than 20 cc/hr which is externally controlled, preferably as an electronic solenoid valve.

### BACKGROUND OF THE INVENTION

There are environmental concerns expressed relating to the amount of methane gas released into the atmosphere. Gas ranges are a target of this concern, even when in the off position. One reason for these concerns relating to release of methane when a gas range is in the off position is that a standard four top burner gas range configuration has up to 14 gas connections inside the appliance where gas may be present 100% of the time (on or off, 24 hours a day). This may provide significantly more connections than other gas appliances such as dryers, furnaces, water heaters, etc. which may have only 2-3 connections to contend with on average. Many of these connections are operated valves which each potentially direct gas flow to specific locations, like top burners, when open.

CSA permits a leak rate of 230 cc/hr for components used in gas appliances. Typically, the customer targets the same leak rate (230 cc/hr) for the entire appliance when in the off position. With up to 14 potential leak sources, some new appliances may fail this standard.

Many gas appliances, other than gas ranges, require redundant solenoid valve constructions having two solenoids within a single housing which has an inlet and outlet with the two solenoids in series between the inlet and the outlet. These double solenoid valves are typically large and have a configuration which limits how and where they can be positioned.

The applicant was recently requested by customers to quote supplying similar double solenoid valves to customers for use with gas ranges. The added safety feature of a double solenoid gas valve is that there would be two valve seats which must be open to permit the flow of gas to an oven or broil burner. Double solenoid gas valves are significantly more expensive than single solenoid gas valves, particularly when coupled with the cost of the electronics which would monitor the solenoids. While double solenoid gas valves throughout a range could provide redundancy, such redundancy would certainly come with an increased cost.

Improved gas ranges are believed to be desirable which may be less prone to leakage than prior art appliances.

### SUMMARY OF THE INVENTION

It is an object of many embodiments of the present invention to provide an improved gas appliance.

It is another object of many embodiments of the present invention to provide a gas appliance having a redundant shutoff valve.

It is yet another object of many embodiments of the present invention to provide a gas appliance having a solenoid shutoff valve disposed upstream of the gas regulator.

Accordingly, providing a positive gas shutoff valve to the appliance at the inlet (upstream from a gas regulator), could eliminate all leak points downstream. This positive shutoff valve, when shut, could be the only potential leak point of the entire system, with backup shutoff being at the other valves of the appliance.

The gas appliance, whether a range or other appliance, has an off configuration which means that it does not intend to consume gas. Some gas may leak by (hopefully within specification). An on configuration exists when at least one function of the appliance intends to consume gas, such as at least one burner being lit, etc. . . . The applicant has at least one solenoid valve capable of meeting the 20 cc/hr leak rate when shut which could function as a master shutoff solenoid upstream of a pressure regulator. One particular solenoid valve has a rating of roughly 119,000 BTU/hr which exceeds the requirement for most gas stoves in the United States. This particular valve is also CE rated, permitting use in appliances in Europe. However, this valve, by itself, is not redundant. It is only with the placement of this valve upstream of a gas regulator in a gas range, that it then can provide the desired redundancy, preferably when coupled to electronics that control the operation of the valve which can provide the logic of if all valves are off, then the master or positive shutoff valve would be shut as well. Other embodiments may have sensors that detect when functions are off and then a processor could send a signal to shut off the master shut off valve. Other valves may have other ratings.

By providing the electrically controlled positive or master shutoff at or near the inlet to the appliance, and preferably at least upstream of a pressure regulator, two separate issues can be simultaneously addressed: (a) the allowable off position leak rate may be cut by up to 90%, and (b) redundancy may be satisfactorily addressed.

A master shutoff valve in communication with the gas inlet, such as between the inlet and a gas regulator, could work in series with separate, potentially smaller, solenoids downstream of a gas pressure regulator. This series arrangement of valves allows the use of smaller single coil solenoids that would likely prove to be more flexible as to where they could be positioned.

For many embodiments, providing a master shut off with redundancy would employ two valves for a single burner system or three valves for a two burner system, and an electronic ignition system (since when the master shutoff valve is shut, there will not be a flow or supply of gas available for a pilot light).

With such a construction, the first valve (master shutoff valve) provides enough BTU capacity to provide flow (when open) for the entire gas range: i.e., enough for all of the top burners, as well as the bake and broil elements. The first valve would also need to provide the desired minimum leak amount, in this case, no more than 20 cc/hr or less. Second and third valves could control the bake and broil burners, if a two burner system. An electronics module would preferably control ignition, flame supervision, and provide valve drive for both bake and broil valves.

When in the off position, no gas is provided downstream of the first valve: gas is preferably stopped at the master solenoid valve at the inlet. When there is a call for heat, the electronics provides a signal to the first valve (master solenoid) to open. Gas then flows as directed toward the bake and broil elements, but first would need to pass through the appropriate bake solenoid valve (second solenoid valve) or broil solenoid valve (third solenoid valve) depending upon the particular operation, or function, desired for the range. The valves (first, second, third, etc.) have at least an on and an off position. Some valves, such as second, third, etc., may be able to adjust gas flow as well when in the on position as would be known by those of ordinary skill in the art. When in the off position, no gas (apart from possible unintended leakage) flows through the valve, whether it be the first, second, third or other valve.

If the direction is for bake, the bake solenoid would open, the electronics would ensure ignition, and the desired temperature and flame would be monitored as directed by the user together with the electronics module. If ignition is not completed in a specified amount of time, the entire system (including the first valve) would shut down, i.e., the master solenoid valve would shut. The electronics module may permit a selected number of purge attempts before potentially shutting down the appliance completely until a service technician permitted continued attempts.

Apart from bake and broil burners (and their second and third valves) for a two burner system, top burners, electrodes (bake and broil) which could act as both igniters and flame sense could be provided, gas pressure regulation systems, and other systems could be provided with more sophisticated ranges. Other gas appliances may benefit from the technology disclosed herein.

### BRIEF DESCRIPTION OF DRAWINGS

The particular features and advantages of the invention as well as other objects will become apparent from the following description taken in connection with the accompanying drawings in which:

FIG. 1 is a schematic representation of a gas appliance of a presently preferred embodiment of the present invention;

FIG. 2 is a rear plan view of the gas appliance of FIG. 1; and

FIG. 3 is a side plan view of the master shutoff valve used with the appliance of FIGS. 1 and 2.

### DETAILED DESCRIPTION OF THE PREFERRED EMBODIMENTS

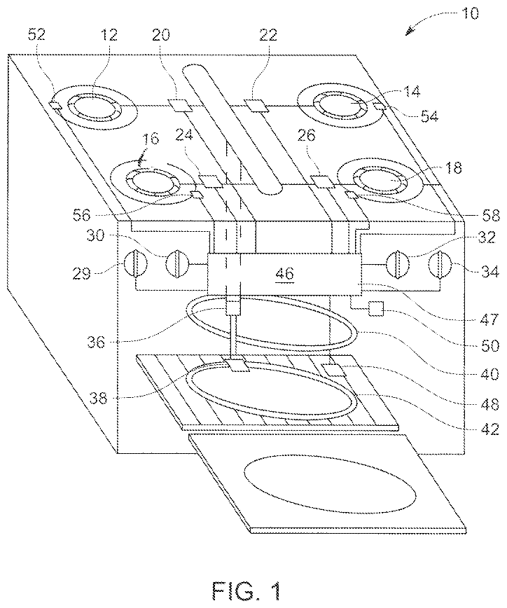

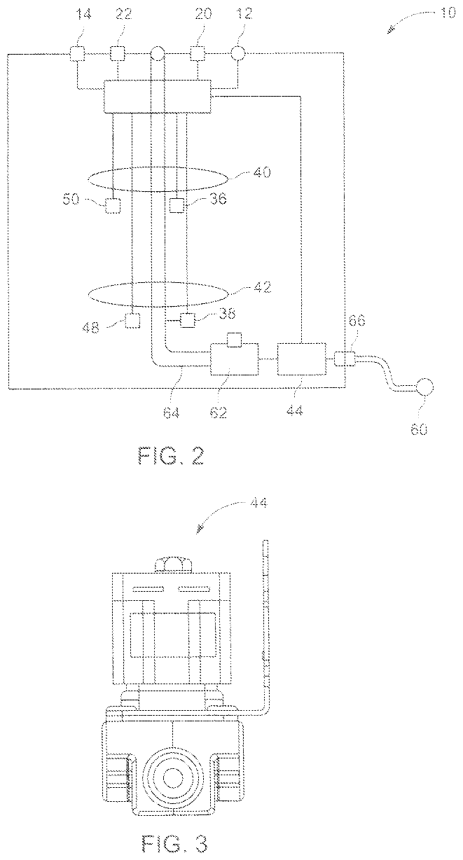

A gas appliance 10 in the form of a gas range is shown of relatively straight forward complexity in FIG. 1. Four top burners 12,14,16,18 each fed by respective single solenoid valves 20,22,24,26 are provided. Other top burners may be fed by analog or mechanical valves directly operated by knobs 29,30,32,34, respectively as are known in the art. Regardless of the type(s) of valve(s) used with the top burners, 12-18, each is respectively ignited with electric ignition systems 52,54,56,58 when desired to operate. Ignition/flame sensors are often part of the ignition systems 52-58.

Many gas ranges regardless of the sophistication of their top burners 12-18 will have at least a bake burner 42 controlled with a solenoid or bi-metal valve, in this case identified as second solenoid valve 38. Many gas ranges will also have a broil burner 40 which may be controlled by solenoid or bi-metal valve, in this case identified as third solenoid valve 36.

The solenoid valves receive input to open from an electronic module 46, which may also include a touch display 47 for the user to control operation of the appliance 10. Bake and broil burners 42,40 will also have corresponding electronic ignition systems 48,50 to ignite the burners when desired which may also provide ignition/flame sensors.

When the stove or appliance 10 is off for prior art appliances similar to the one illustrated, gas would proceed from an external source 60 (either natural gas, propane, etc.) normally at a residential home through a gas regulator 62 to manifold 64 supplying the various valves 20-26, 36,38. Gas would be within the manifold 64 at 100%, 24 hours a day. However, the applicant has installed a master solenoid valve, first valve 44 to prevent such a situation.

The first valve 44 has an open and a shut configuration. The first valve 44 is opened when the electronic control module 46 receives an input requiring heat at any of the top burners 12-18 or the bake or broil burner 42,40. The first valve 44 is further shut by the electronic control module 46 when no signal is received, such as in the event of power failure, or when the electronic control module 46 recognizes an off condition of the range, such as if none of the top burners 12-18 and the oven (both bake and broil burners 42,40 are off).

First valve 44 can preferably located at or near the inlet 66 upstream of the pressure regulator 62 so that it may solve two issues at the same time: (a) cut the allowable off position leak rate by up to or exceeding 90% of the allowable leak rate (or permit achieving a minimal leak rate), and (b) add redundancy, so that if any of the other valves in the system were to leak by, shutting the first valve 44 would secure gas pressure upstream of that valve to no more than the gas in the manifold 64. Preferable first valves 44 can achieve a 20 cc/hr or less leak rate which is significantly less than the 230 cc/hr leak rate permitted by CSA standards. [At least some first valves 44 manufactured by the applicant have a rating of 119,000 BTU/hr which is greater than the BTU requirements for most gas ranges sold into the United States.] Other valves may be rated differently.

Furthermore, many first valves 44 may already be CE rated for sale into the European market.

Having a master shut off valve, first valve 44, at the inlet 66 could work in series with separate smaller solenoid valves (such as 36,38) downstream of the gas pressure regulator 62. Such a series arrangement could allow for the use of smaller single coil solenoid valves that could prove to be more flexible as to where they may be positioned.

Providing a first valve 44 provides redundancy not known by the applicant such as by providing first valve 44 in combination with a second solenoid valve utilized with a single burner system or providing first valve 44 in combination with second and third solenoid valves with a two burner system. In all of these embodiments, an electronic ignition module is preferably provided either as a portion of the electronic control module 46 or separately as electronic ignition systems 52-58 and 48, 50 for the various burners. The electronic control module 46 may control ignition to the various burners as well as possibly monitor the existence of a flame at any of the various burners.

In these various embodiments, the first valve 44 has enough BTU capacity to supply the entire range 10 (enough for all top burners, bake and broil burners). The first valve 44 is also preferably manufactured in an effort to meet a predetermined maximum leak rate, currently 20 cc/hr, but other specification could be provided for other embodiments. The second, third and other solenoid valves 36,38 (20-28, and/or others) are all in series, possibly separately with the first valve 44. These other valves 36,38, 20-28, etc. also control the bake, broil elements, top elements, etc. The electronic module 46 controls ignition, flame supervision, valve drive for both bake and broil valves, as well as possibly the top burners, if they employ solenoid valves as well.

In the off position, no gas is received downstream of the first valve 44. The electronic module 46 may have a signal sent to have the various valves, including the first valve 44, second valve 38, third valve 36, etc., in the off position. Gas stops as the inlet of the first valve 44. When there is a call for heat, or other gas use, by a portion of the appliance 10, the electronic control module 46 sends a signal to open the first valve 44,. Gas then proceeds toward the appropriate burner, such as a bake or broil burner, by way of example. The appropriate solenoid valve for the appropriate burner is either then opened or is simultaneously opened with the opening of the first valve 44. If the call is for bake, the bake solenoid opens, and the electronic control module 46 preferably monitors to ensure ignition within a specified amount of time along with having the second valve 38 positioned to open along with the first valve 44. If the ignition process is not completed within the specified amount of time, the specific solenoid is shut (such as the bake or second solenoid valve 38). The first solenoid valve 44 is also shut when shutting the second solenoid valve 38 (for some embodiments, the electronic module 46 will employ logic to ensure no other valve is open providing heat before directing the first valve 44 to be shut. If the bake solenoid were the only burner supposed to be working, then the electronic control module 46 could allow a specified amount of purge times and attempt a set number of relighting attempts before shutting down completely (which would shut the first valve 44, potentially regardless of other operations of the appliance 10 desired at the time). For bake valves, the electronic control module 46 could control the amount of gas flow through the valve to attempt to provide a specific bake temperature. If a call is to broil, the third valve 36 may be opened with the first valve 44 by the electronic control module 46.

Other components could be added to the system apart from just a single burner controlled by a second solenoid valve having a corresponding electronic ignition control for varying degrees of complexity and sophistication. Bake and broil elements both could be provided with corresponding solenoid valves; electrodes (possibly for both bake and broil) could be provided which act as both ignitors and flame sensors could be used with the electronic ignition controls; gas pressure regulation and other features could also be provided.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A gas appliance as shown and described herein.

2. A gas appliance having a master gas shutoff valve as shown and described herein upstream of a gas regulator. 1. A gas appliance having an off configuration with no intended consumption of gas, and an on configuration whereby gas is intended to be consumed for at least one function, said gas appliance comprising:
a gas inlet;
a first electronic solenoid valve having an on and off position in communication with the gas inlet, wherein when in the off position, gas flow is stopped form flowing through the first electronic solenoid valve;
a second valve selectively permitting gas flow to a first burner, said second valve having at least an on and off position, whereby when in the off position, gas is stopped from flowing to the first burner; and
wherein the second valve is in series with first electronic solenoid valve; and when the gas appliance is in an off configuration, the first electronic solenoid valve and the second valve are both in the off position.

2. The gas appliance of claim 1 wherein the second valve is an electronic solenoid valve.

3. The gas appliance of claim 2 further comprising an electronic module, and when the gas appliance is in the off configuration, the first and second valves are turned off by the electronic module.

4. The gas appliance of claim 3 wherein the electronic module selectively controls ignition to the first burner.

5. The gas appliance of claim 3 wherein the electronics module monitors the existence of a flame at the first burner.

6. The gas appliance of claim 3 wherein the electronics module controls positioning of the second valve to control an amount of gas flow through the second valve and first burner.

7. The gas appliance of claim 1 wherein the gas appliance has a regulator in series with the first electronic solenoid valve and the gas inlet and the first electronic solenoid is located intermediate the regulator and the gas inlet.

8. The gas appliance of claim 1 wherein the gas appliance is a gas range.

9. The gas appliance of claim 8 wherein the first burner is a bake burner

10. The gas appliance of claim 8 further comprising at least one top burner having a top burner solenoid valve in series with the at least one top burner.

11. The gas appliance of claim 1 further comprising a third valve in series with the first electronic solenoid valve, and wherein the third valve is in series with first electronic solenoid valve; and when the gas appliance is in an off configuration, the first electronic solenoid valve and the third valve are both in the off position.

12. The gas appliance of claim 11 wherein the third valve is an electronic solenoid valve.

13. The gas appliance of claim 12 further comprising an electronic module, and when the gas appliance is in the off configuration, the first, second and third valves are turned off by the electronic module.

14. The gas appliance of claim 13 wherein the electronic module selectively controls ignition to the second burner.

15. The gas appliance of claim 14 wherein the electronics module monitors the existence of a flame at the second burner.

16. The gas appliance of claim 13 wherein the electronics module controls positioning of the third valve to control an amount of gas flow through the third valve and second burner.

17. The gas appliance of claim 12 wherein the gas appliance has a regulator in series with the first electronic solenoid valve and the gas inlet and the first electronic solenoid is located intermediate the regulator and the gas inlet.

18. The gas appliance of claim 12 wherein the gas appliance is a gas range.

19. The gas appliance of claim 18 wherein the second burner is a broil burner.

20. The gas appliance of claim 18 further comprising at least one top burner having a top burner solenoid valve in series with the at least one top burner.
